(19) United States
(12) Patent Application Publication
(10) Pub. No.: US 2023/0126285 A1
(43) Pub. Date: Apr. 27, 2023

(54) REDOX FLOW BATTERY SYSTEM AND OPERATING METHOD

(71) Applicant: VOITH PATENT GMBH, Heidenheim (DE)

(72) Inventor: Thomas Lüth, Freiburg (DE)

(21) Appl. No.: 17/913,948

(22) PCT Filed: Mar. 10, 2021
(86) PCT No.: PCT/EP2021/056031

§ 371 Date: Sep. 23, 2022

(30) Foreign Application Priority Data
Mar. 24, 2020 (DE) 10 2020 108 068.9

(51) Int. Cl. H02J 7/00; H02M 3/335; H01M 8/18; H01M 8/04858

(52) U.S. Cl. CPC H02J 7/0016; H02M 3/33584; H02J 7/0047; H01M 8/188; H01M 8/04865; H02J 2207/20

(57) ABSTRACT

A redox flow battery system includes at least two battery modules, a bidirectional converter, and a controller. The battery modules are connected in series and are connected to the converter. Each battery module has a cell array with a plurality of redox flow cells and a tank device for storing electrolyte and supplying electrolyte to the cell array. The battery system further includes a DC-to-DC converter for each battery module, one terminal of each DC-to-DC converter being connected to one battery module, and a second terminal of each DC-to-DC converter being connected to a common DC bus. An additional converter is connected to the DC bus. The controller is connected to the additional converter and to the DC-to-DC converters in such a way that the controller can control the additional converter and the DC-to-DC converters.

The invention relates to a redox flow battery system and to a method for operating such a system. The invention relates in particular to redox flow battery systems with a high output voltage. The method according to the invention relates to a method for reducing or eliminating imbalances between series-6 connected battery modules that occur during charging and discharging of the battery system.

In order to obtain a high output voltage in redox flow battery systems, multiple cells are usually electrically connected in series. This arrangement is referred to as a stack. However, this cannot be continued as desired because otherwise the shunt current caused by the electrolyte would become intolerably high. The output voltage can, however, be increased further when multiple stacks are connected in series, with each stack having a separate tank unit. A unit of this kind composed of a stack and an associated separate tank unit is referred to as a battery module. However, the individual battery modules produced are not identical due to the inhomogeneity of the raw materials used and manufacturing fluctuations, and therefore such battery systems suffer from fact that an imbalance among the battery modules can occur, which disadvantageously influences the performance of such a battery system.

The prior art discloses battery systems and associated operating methods that can reduce a dangerous imbalance of this kind. This is usually referred to as balancing.

WO 2020/030762 A1 deals with the imbalance of the state of charge (SoC) of the battery modules. In this case, the states of charge of the individual electrolyte tanks are measured and compared. If the difference between the states of charge exceeds a threshold value, the number of series-connected cells in the stacks is adjusted so that the electrolytes that are charged less are discharged by fewer cells than the electrolytes that are charged more, or that the electrolytes that are charged less are charged by more cells than the electrolytes that are charged more.

WO 2018/107097 A1 deals with the imbalance of the state of charge of the battery modules. The reduction of the imbalance is achieved by virtue of the fact that, after the SoC values have been measured, the SoC value of a battery module is matched to a target SoC value by virtue of in at least one module a portion of the stored energy being fed to an electrical load.

The inventor has set themselves the problem of specifying a redox flow battery system and an operating method, where imbalances can be reduced in an alternative manner.

The problem is solved according to the invention by way of a battery system and an operating method in accordance with the independent claims. Further advantageous embodiments are found in the dependent claims.

The present application in this case discloses two different solution approaches that can be executed independently of one another or, particularly advantageously, in combination.

The solutions according to the invention are explained in the following text with reference to figures. The figures show in detail:

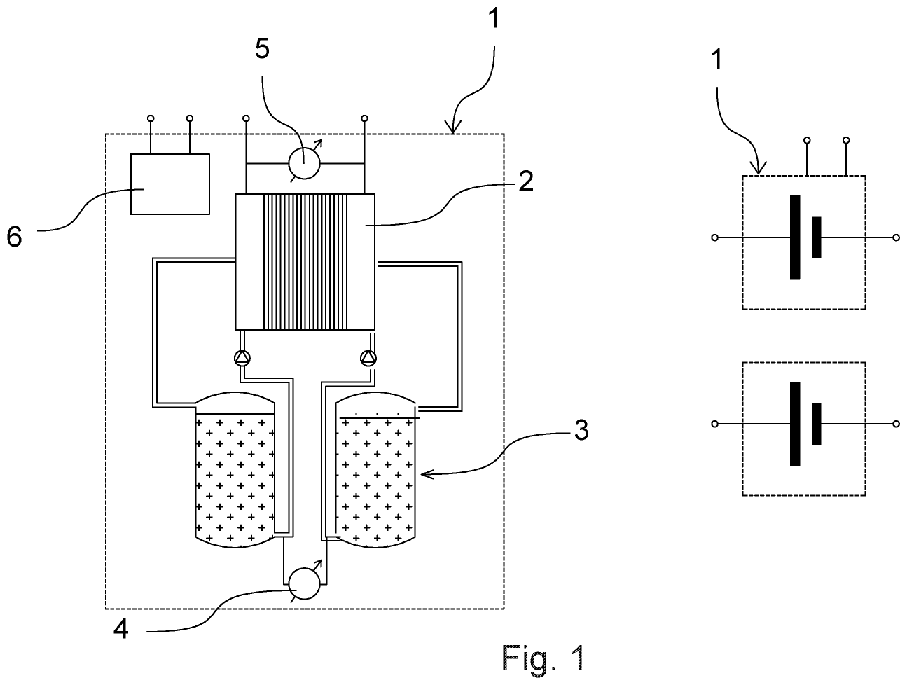

FIG. 1 a battery module

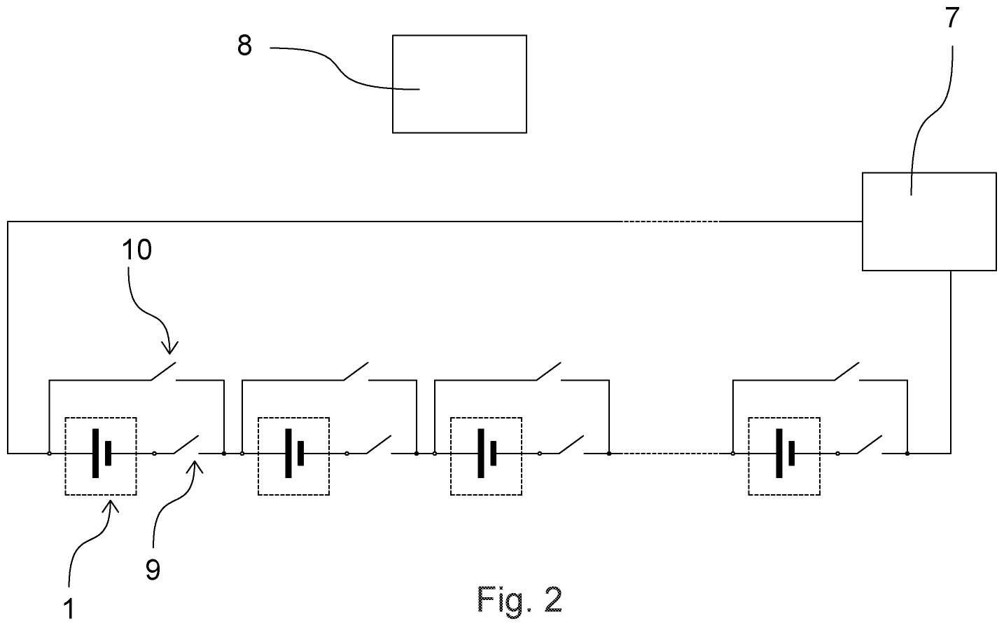

FIG. 2 a battery system

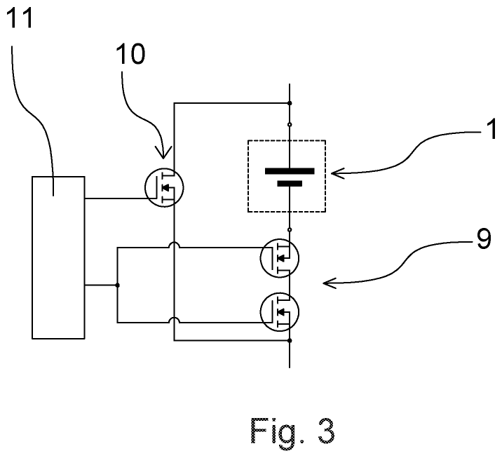

FIG. 3 an inventive embodiment of a battery system (detail)

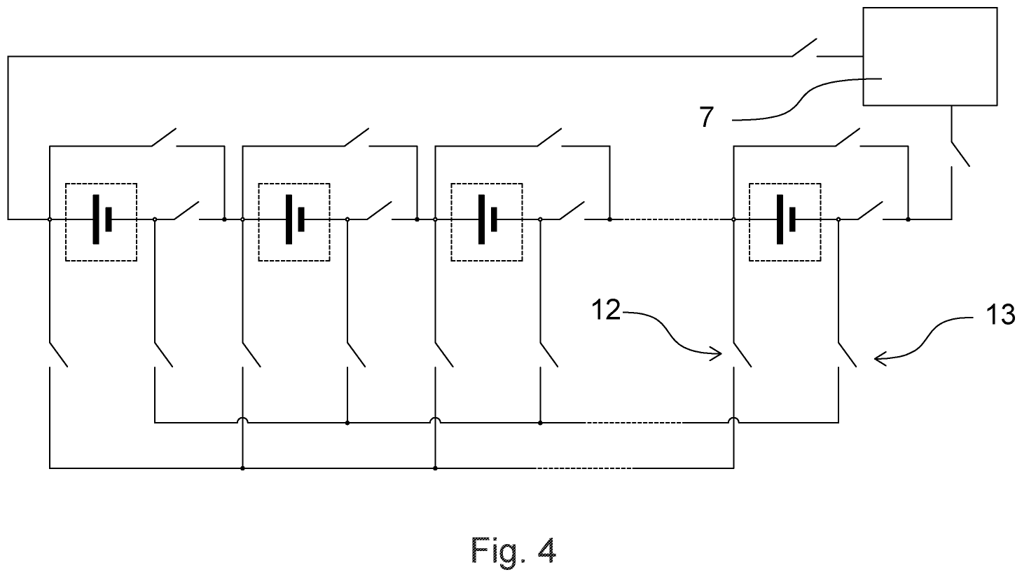

FIG. 4 a battery system according to the invention in another embodiment

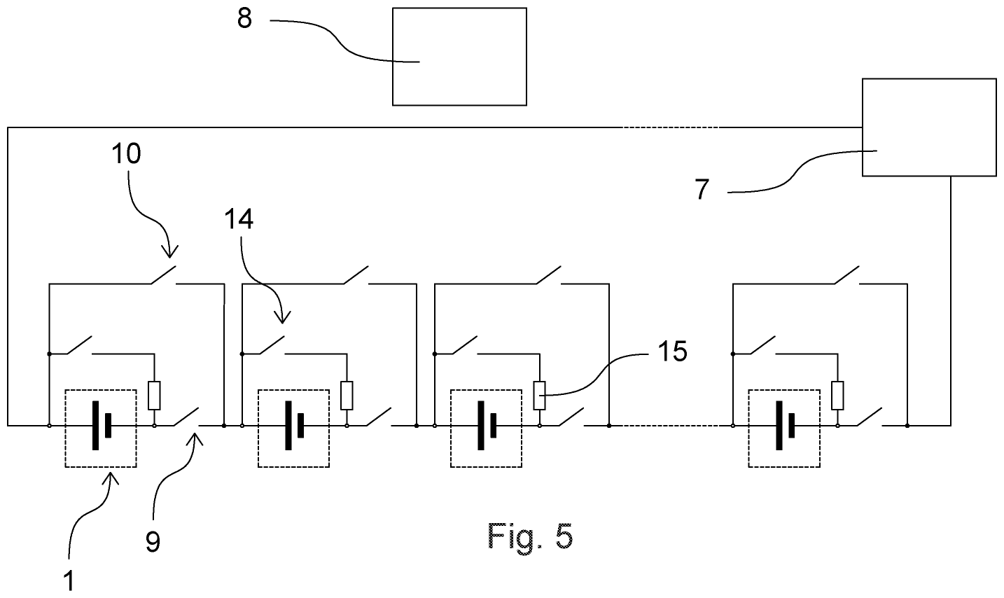

FIG. 5 a battery system according to the invention in another embodiment

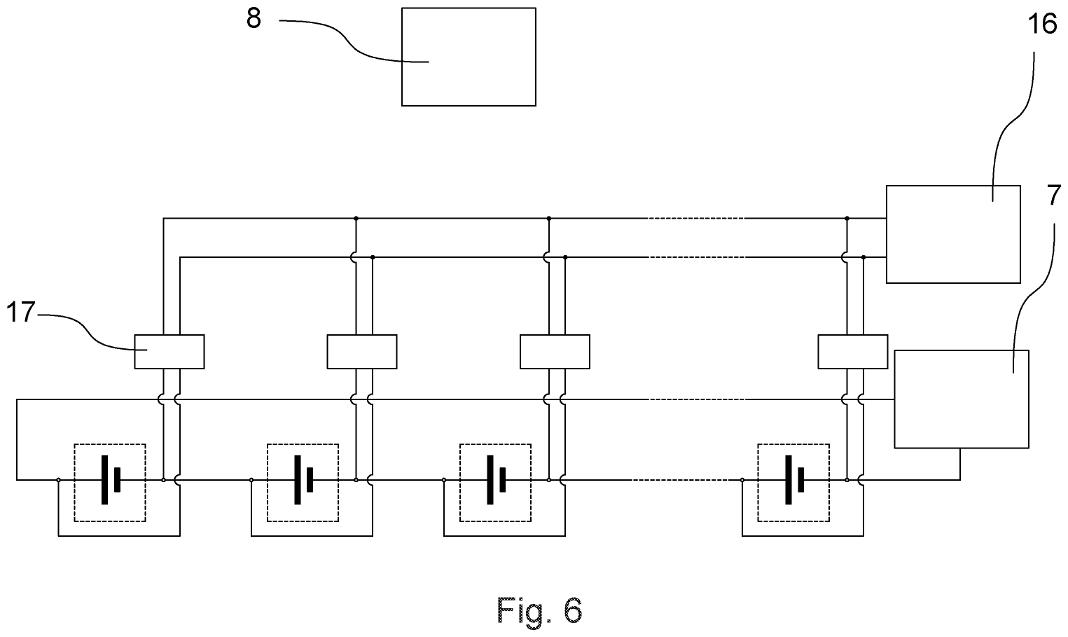

FIG. 6 a battery system according to the invention in another embodiment

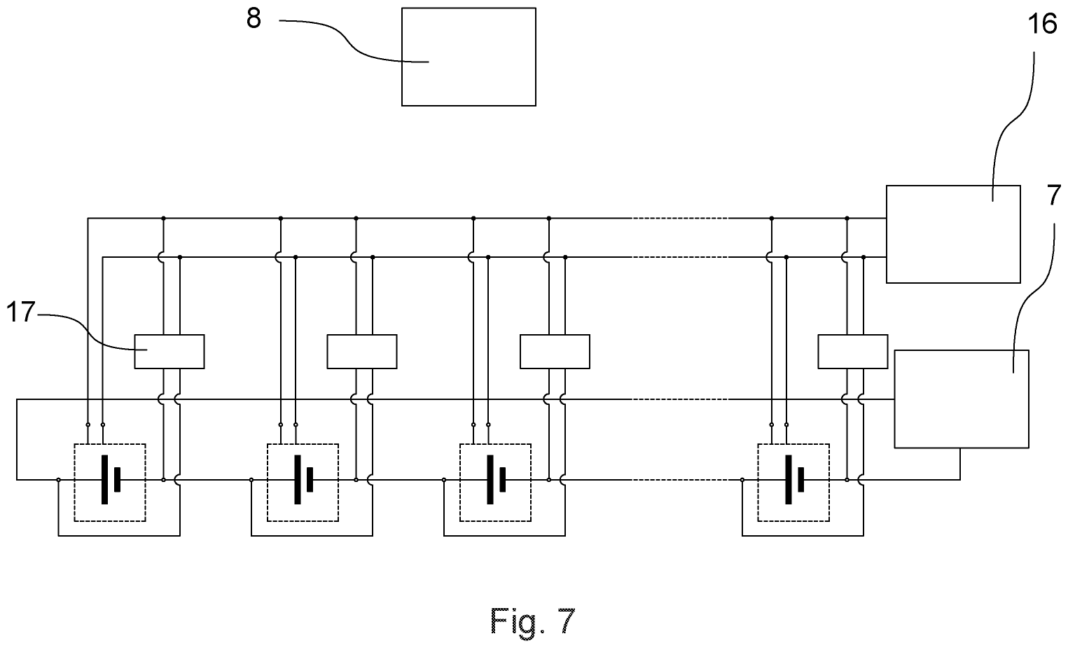

FIG. 7 a battery system according to the invention in another embodiment

The left-hand side of FIG. 1 shows a schematic illustration of a battery module. The battery module is denoted by 1. The battery module comprises a cell arrangement, denoted by 2, a tank device, denoted by 3, and a measuring device for detecting the control variable. The cell arrangement 2 is an arrangement of a plurality of redox flow cells that can be arranged as desired. For example, it may be one individual cell stack, a series connection of multiple stacks, a parallel connection of multiple stacks, or a combination of a series and parallel connection of multiple stacks. In any case, all of the cells of the cell arrangement 2 contribute to storing electrical energy in the battery module 1 during charging or to delivering electrical energy when the battery module 1 is discharged. The tank device 3 is used to store the electrolyte and to supply the cell arrangement 2 with electrolyte. For this purpose, the tank device 3 comprises, apart from a few exceptions, at least two tanks, a pipe system for connecting the tanks to the cell arrangement 2 and pumps for conveying the electrolyte. In this case, FIG. 1 shows two separate pumps. The electrolyte could just as easily be conveyed using a double-headed pump, that is to say using two pumps that are driven by a joint motor. The tank device 3 is designed in this case so that it can supply electrolyte to all of the cells of the cell arrangement 2. That is to say if the pumps convey the electrolyte, the electrolyte flows through all of the cells of the cell arrangement 2. Therefore, all of the cells of the cell arrangement 2 always contribute to charging the electrolyte of the tank device 3 or all of the cells of the cell arrangement 3 contribute to discharging the electrolyte of the tank device 3 when the battery module 1 is charged or discharged.

The battery module 1 that is illustrated in FIG. 1 comprises two measuring devices for providing a controlled variable. In this case, the measuring device denoted by 4 is a measuring device for providing what is known as the open-circuit voltage (OCV). The OCV value is a measure of the state of charge (SoC) of the battery module. The measuring device denoted by 5 is a measuring device for providing the terminal voltage of the cell arrangement 2 and thus also the battery module 1. During charging or discharging of the battery module 1, the terminal voltage differs from the open-circuit voltage by the voltage that is dropped across the internal resistance of the cell arrangement 3. An alternative to OCV value determination is what is known as Coulomb counting, which also constitutes a measure for the state of charge of the battery module. A measuring device for providing the current that flows through the series-connected modules is required for this. Such a measuring device for Coulomb counting could therefore also be implemented outside of the battery modules 1, such that a battery module 1 thus optionally comprises a measuring device for providing a controlled variable. In any case, a battery system (see below) comprises at least one measuring device for providing the controlled variable for each battery module 1 of the battery system.

The battery module 1 furthermore comprises auxiliary systems, which are illustrated by the rectangle with the reference sign 6. The auxiliary systems 6 are supplied with current from outside of the battery module 1 by way of the two terminals. Among other things, the auxiliary systems 6 are used to feed the pumps, of a possibly present ventilation device and the like.

The right-hand side of FIG. 1 shows symbolic representations of the battery module 1. In this case, in addition to the terminals of the cell arrangement, the upper representation also shows the terminals of the auxiliary systems. These are not shown in the lower representation. The symbolic representations are used in the following text. If the lower representation is used, this does not mean that the battery modules that are illustrated would not comprise any auxiliary systems, but it means only that the auxiliary systems do not play any role in the respective context.

FIG. 2 shows a schematic illustration of a battery system in a first embodiment. The battery system comprises at least two battery modules, of which one is denoted by 1, a bidirectional power conversion system (PCS) denoted by 7 and a control device denoted by 8. The battery modules 1 are connected in series and are connected to the power conversion system 7. FIG. 2 illustrates four battery modules, wherein the dashed lines in the series circuit are intended to indicate the number of further modules. The power conversion system 7 takes over the connection of the battery system to the grid or to a superordinate electrical system. The battery system furthermore comprises a first switch, of which one is denoted by 9, and a second switch, of which one is denoted by 10, for each battery module 1. The first switches 9 are arranged in each case in series with the battery modules 1, where the side of the respective battery module on which the associated switch 9 is arranged is insignificant. The second switches 10 are arranged in each case in a bypass line (bypass) around a respective battery module 1 and the associated first switch 9. FIG. 2 illustrates all of the switches 9 and 10 in the open state. In reality, in almost all of the operating methods according to the invention that are described in detail in the following paragraphs, the switches are actuated by the control device 8 so that, of each switch pair composed of a first and second switch, exactly one switch is closed and one switch is open (alternately open and closed). That is to say one switch pair has exactly two switching positions, wherein the associated battery module 1 is in the series circuit of the battery system in the first switch position (first switch 9 closed and second switch 10 open) and the associated battery module 1 is disconnected from the series circuit of the battery system by the bypass line in the second switch position (first switch 9 open and second switch 10 closed). In this case, opening the first switch 9 when the switch 10 is closed prevents the module from being discharged via the bypass line. The control device 8 is connected to each battery module so that it can detect the measurement values of the measuring devices 4 and 5. If the battery system comprises one or more measuring devices that are not part of the battery modules 1, the control devices then of course are also connected thereto in order to be able to detect measurement values thereof. For example, a measuring device for Coulomb counting could also be part of the control device 8. Furthermore, the control device 8 is connected to each of the switches 9 and 10 so that it can determine the respective switch position in order to connect the battery modules 1 into the series circuit or out of the series circuit. These connections can also be made wirelessly.

In a battery system according to FIG. 2 with fully identical battery modules 1, there could be no dangerous imbalance. However, real battery modules 1 differ on account of manufacturing fluctuations and ageing processes. Furthermore, different operating conditions, for example temperature differences, of the individual modules can cause a different behavior thereof. For this reason, real battery modules have different efficiency values and different internal resistances. At a given charging or discharge current, a higher efficiency leads to the end state of the relevant battery module being reached more quickly. Since the same current flows through all of the battery modules 1 in the series circuit according to FIG. 2, the modules with a higher efficiency reach the end state more quickly than the modules with a lower efficiency. To prevent damage, the charging or discharge process has to be terminated already when a module reaches the respective end state. In this way, without this effect being balanced, the useful storage capacity of such a battery system reduces with each cycle that is run through (capacity fading). The different internal resistance of the modules has a similar effect. There are upper and lower limit values for the terminal voltage that may not be exceeded or undershot. Even with an identical efficiency, a module with a higher internal resistance reaches the respective limit value of the terminal voltage more quickly during charging or discharging than a module with a lower internal resistance. When the first module reaches a limit value, the respective process has to be terminated in a manner which thus also leads to a reduction in the useful capacity of the battery system. As an alternative, the power of the system could also be reduced. In any case, these effects lead to the system being adversely affected. Balancing is intended to reduce or completely eliminate the described effects in order to keep the useful capacity of the battery system permanently a high level or to eliminate the adverse effects described. On the other hand, successful balancing makes it possible to use cells with a comparatively high variance in terms of efficiency and/or internal resistance, which of course is reflected in reduced initial costs.

The following text specifies a method according to the invention for reducing imbalances of the battery system illustrated in FIG. 2 during the charging and discharging of the battery system, wherein all of the steps mentioned are course carried out during the charging or discharging of the battery system, that is to say the charging or discharging is not interrupted thereby.

The method according to the invention for reducing imbalances that occur during the charging and discharging of the battery system comprises in a first embodiment the following steps:
detecting the measurement values of the measuring device for providing a control board variable for each battery module 1 by way of the control device 8;
if at least one measurement value of a first battery module 1 differs from a measurement value of a second battery module 1 at a first point in time:
   the control device 8 controls the number of battery modules 1 in the series circuit in order to reduce the difference between the measurement values of the first and second battery module 1 at a later second point in time, wherein one of the two battery modules 1 is in the series circuit for less time than the other battery module 1 over the period between the first and second point in time during the charging or discharging of the battery system.

When a battery system with a plurality of battery modules is operated over a sufficiently long period without balancing, that is to say is charged or discharged, then a state generally arises in which the measurement values of the controlled variable for each battery module represent a statistical distribution. In each case, the condition that at least one measurement value of a first battery module 1 differs from a measurement value of a second battery module 1 is then satisfied. Of course, it is the aim of the balancing in such a system with many battery modules to reduce the range of the distribution of the measurement values at a later point in time as far as possible or to match all of the measurement values to one another completely in the ideal case. This of course automatically leads to the measurement values of the first and second battery module at the later point in time also approximating one another. This is achieved according to the invention in that at least a portion of the battery modules are temporarily switched out of the series circuit of the battery system, wherein the modules that are switched out in this time do not participate in the charging or discharging of the system, whereas the modules that remain in series do take part.

In this case, care should be taken to ensure that not too many battery modules are taken out of the series circuit at the same time, which could lead, for example, to a reduction in the voltage applied to the PCS 7, since this voltage results from the sum of the terminal voltages of all of the battery modules in the series circuit. The control device 8 controls the number of battery modules 1 in the series circuit, therefore also in this relationship, that is to say in order to ensure smooth operation of the battery system at any time. In addition to the lower limit voltage of the power conversion system 7, in this case other parameters and boundary conditions can also of course be taken into account, such as the upper limit value of the power conversion system 7, for example.

To this end, the control unit 8 can, for example, monitor the voltage applied to the PCS 7 and ensure an appropriate switching behavior. As an alternative, a maximum number of modules that could be taken out of the series circuit could also be defined directly. It is also conceivable for such a maximum number to still depend on other parameters, for example the state of charge of the system or of any module. For example, at a first state of charge, it could be permitted to simultaneously switch out a maximum of n modules and, at a second state of charge, it could be permitted to simultaneously switch out a maximum of m modules, wherein n is not equal to m. Further conceivable parameters are the charging or discharge current or the power of the PCS 7.

The method according to the invention can be further clarified when one considers that measurement values and thus the values of the corresponding controlled variable of the battery modules monotonically move toward a final value during charging or discharging of a battery system. However, the “speed” of this movement is different for the battery modules, such that some modules “lead” and others “lag behind”. It is thus the aim of balancing to keep the “migrating group” of modules together although each module advances at a different speed. The control device achieves this aim by virtue of the fact that the more rapid modules from time to time have to take “obligatory breaks” (temporary removal from the series circuit), while the slowest module advances permanently. In this case, the control device ensures that too many modules do not take a break at any time. In this case, the control device has two controlled variables: the length of the breaks and the break frequency.

It may be expedient for threshold values for the deviation in the measurement values to be used for the described method according to the invention. A first threshold value could be defined for the use of the method according to the invention, that is to say a threshold value that must exceed the difference between the measurement value of the first battery module and the measurement value of the second battery module at a first time in order for the balancing mechanism to be triggered. A second threshold value could be defined for suspending the balancing mechanism, that is to say a threshold value that must undershoot the difference between the measurement value of the first battery module and the measured value of the second battery module at a later second time in order that the balancing mechanism is suspended at this second time. It is clear that the second threshold value has to be selected to be lower than the first threshold value. In particular, the second threshold value is useful for eliminating the negative influence of measurement inaccuracies. As an alternative, the measurement values could cause also have noise removed from them using a suitable filter.

However, the method according to the invention can be carried out just as well without threshold values. For example, by making use of the fact that it is possible to determine empirical values for the period after a given battery system in a given charging or discharging process has become unbalanced, such that a balancing intervention is needed. The same applies for the period over which the balancing mechanism has to be carried out in order to bring a given battery system back to a balanced state in a given charging or discharging process. The control unit of a given battery system can advantageously obtain these empirical values using a suitable algorithm through self-learning by running through some charging/discharging cycles. Equally, the empirical values can be adjusted if the battery system should change in this regard, for example on account of aging effects over a relatively long operating period. Equally, the properties of the individual battery modules 1 can be determined, that is to say which battery modules are operating at a high efficiency or are affected by a high internal resistance, in order to determine which battery modules empirically have to take a break more often and/or for longer in order to keep the “migrating group” together (also see below). When using such empirical values, there is therefore no need for permanent detection or evaluation of the measurement values of the controlled variables. The same applies for a model-based procedure in which the behavior of the battery modules can be predicted using a model. In this case, the model can be adapted to the respective battery system using measurement variables and suitable parameters.

It is also conceivable for the balancing mechanism according to the invention to be carried out at least over a certain period without further detection or evaluation of measurement values by virtue of the more rapid modules continually taking long or frequent breaks accordingly. Imbalances that occur continually are thus corrected immediately without the differences in the controlled variable being detected or evaluated permanently. Of course, there is also nothing against carrying out this continual balancing with continual detection and evaluation of the measurement values.

In the embodiments of the method according to the invention that manage permanent detection or evaluation of the measurement values of the controlled variables, the respectively required break length and break frequency is determined again for each battery module once or at later times. A self-learning algorithm or a model-based method can also be used for this purpose. This process and also the determination of the above-described empirical values for the mentioned periods could also be referred to as calibration of the balancing mechanism. Such calibration could be carried out at the factory, that is to say even before delivery to the customer, or else upon first initialization. At least during this calibration, it is necessary for the method according to the invention to be carried out in the form that is specified above (that is to say with detection and evaluation of the measurement values). In the cases where the balancing mechanism is carried out without detection and evaluation of the measurement values, it is recommended that the success of the balancing is checked with reference to the measurement values at least from time to time. In the event of unsatisfactory balancing, it is then possible to carry out calibration again.

The most general form of the method according to the invention (that is to say carrying out the balancing mechanism—BM) can thus be defined as follows:

a method for reducing imbalances that occur during the charging and discharging of the battery system, comprising the step (BM) of:
the control device 8 controls the number of battery modules 1 in the series circuit in order to reduce the difference between a first and second battery module 1 in terms of a controlled variable, wherein one of the two battery modules 1 is in the series circuit for less time than the other battery module 1 over a period during the charging or discharging of the battery system.

However, it is at least temporarily necessary to monitor the measurement values of the controlled variables in order to obtain a termination criterion for the charging or discharge process of the battery system. In the case of successful balancing, however, monitoring the measurement values of a single arbitrary module is sufficient for this.

At this point, it is noted that WO 2020/030762 A1 discloses in FIG. 4 an arrangement that is analogous to the arrangement of FIG. 2 of the present application, wherein the switches 1221 and 1222, which are referred to as outer circuit switches, correspond to the first and second switches (9, 10) of the present application. However, WO 2020/030762 A1 specifies that the purpose of use of the outer circuit switches 1221 and 1222 is that they are used for infrequent eventualities, such as, for example, when the electrolyte tank is leaking or when the electrolyte is exchanged (“The latter switching is likely to be infrequent and for eventualities such as electrolyte leakage or replacement”—see last sentence of the description). WO 2020/030762 A1 therefore neither discloses nor suggests the above-described method of the present invention.

The inventor has identified that the method according to the invention presented above carried out particularly advantageously in the first and the second switch of the battery system described above in connection with FIG. 2 are designed using semiconductor transistors. FIG. 3 shows a particularly advantageous embodiment of the switch design according to the invention with semiconductor transistors, wherein FIG. 3 shows only one battery module and the associated switches. All of the other battery modules including associated switches of the battery system according to the invention are designed correspondingly in this embodiment.

The first switch 9 comprises two normally off MOSFETs, the channels of which are connected in series so that one of the reverse diodes always blocks in both current directions, wherein the reverse diodes are not illustrated in FIG. 3 for the sake of clarity. The second switch 10 comprises one normally off MOSFET. The battery system comprises at least one switch unit, which is denoted in FIG. 3 by 11. The gate terminals of the MOSFETs are connected to the switching unit 11, wherein the gate terminals of the two MOSFETs from the first switch 9 are also connected to one another so that said gates are always actuated simultaneously. The mentioned connection of the gates can also be omitted if the switching unit 11 internally ensures simultaneous actuation of the relevant gates. A respective switching unit 11 can be provided for each switch pair (9, 10), or one switching unit 11 operates multiple switch pairs (9, 10) or else all switch pairs. In the two latter cases, the switching unit 11 must of course have a correspondingly large number of independent terminals so that the connected switch pairs can be switched independently of one another. The switching unit 11 or switching units 11 can be integral components of the control device 8.

The use of MOSFETs enables the wear-free and rapid execution of the switching processes that are required for the above-described method according to the invention, which is particularly advantageous when frequent but short breaks are used for the purpose of balancing. In this case, the arrangement of the MOSFETs according to the invention prevents undesired discharging of a battery module during the time in which it is not in the series circuit and therefore does not take part in the charging or discharging of the battery system. Additionally, each of the switches 9 and 10 can optionally comprise a relay, which is arranged in parallel with the MOSFETs. As a result, the respective switches can also be activated using the relays in a loss-free manner, which is advantageous when the relevant switch is intended to be activated only infrequently.

It should be mentioned that in FIG. 3 the MOSFETs that are illustrated are designed as n-channel MOSFETs. However, the arrangement according to the invention is not restricted to such MOSFETs. P-channel MOSFETs can just as easily be used.

FIG. 4 shows another embodiment of a battery system according to the invention. The battery system additionally comprises, for each battery module, a third and fourth switch, which are denoted by 12 and 13, and lines, wherein the additional switches and the lines are connected to one another and to the battery modules so that all of the battery modules are connected in parallel when all of the additional switches are closed. All of the first and second switches of course have to be open for this purpose. The parallel connection of the battery modules leads to the terminal voltages of the modules matching, wherein balancing currents flow between the battery modules. The parallel circuit shown can therefore be used for balancing. In this case, all of the modules or else only some of the modules, that is to say at least two modules, for example the respectively quickest and slowest modules, can be connected in parallel for a defined period. The additional switches are also activated by the control device, which is not illustrated in FIG. 4 for reasons of space.

In principle, the battery modules could also be charged or discharged in parallel connection by the PCS 7. To this end, however, in a high-voltage battery system of the generic type, the PCS 7 is generally not designed so that balancing through parallel connection cannot be carried out during the charging or discharging.

FIG. 4 also shows two additional switches, using which the PCS 7 can be isolated from the interconnected battery modules. This may be advantageous. Where necessary, only one isolating switch can also be used. Such a switch or such switches can also be used in all of the other embodiments.

FIG. 5 shows another embodiment of a battery system according to the invention. The battery system additionally comprises, for each battery module 1, a further fifth switch, of which one is denoted by 14. It should be mentioned that the reference to a “fifth” switch serves only for clarity and does not imply that, when a battery system comprises a fifth switch, this automatically would have to also comprise a third and fourth switch. Furthermore, the battery system comprises, for each battery module 1, a resistor, of which one is denoted by 15. The fifth switch 14 and the resistor 15 are in this case each arranged in a further bypass line around each battery module 1 so that each battery module 1 is short-circuited by means of a resistor 15 when the associated switch 14 is closed. The fifth switch 14 is also activated by the control device 8. With the aid of the arrangement of FIG. 5, each battery module can be discharged selectively by means of a fifth resistor. If one or more of the fifth switches 14 are closed during the charging or discharging of the battery system, a portion of the charging or discharge current flows past the respective battery system 1. This can be used for balancing. However, this type of balancing is associated with the loss of electrical power and is therefore used only as an additional balancing method to the other methods, such that the balancing can be made more flexible and improved through this additional option. Since heat is released into the resistors in this way, the switching of the fifth switch can advantageously be carried out in pulsed fashion in order to prevent excessive heating.

When the first and second switches 9, 10 are designed according to FIG. 3, the result is an alternative option for achieving the effect that has just been described. As a result of the fact that the MOSFETs have a finite channel resistance, a battery module can also be short-circuited simply by simultaneously closing the first and second switches 9, 10 selectively by means of the channel resistor of said switch. In this embodiment of the method according to the invention, the mentioned switches are therefore not in any case opened and closed in alternation, as described above. In this case, the two switches 9 and 10 together de facto constitute the fifth switch 14. The state in which the two switches 9 and 10 are closed at the same time could also be paraphrased as the associated battery module being “partly” taken out of the series circuit since only a portion of the charging or discharge current still flows through the module and the other portion flows around the module. The phrase “The control device 8 controls the number of battery modules 1 in the series circuit” is therefore also intended to be understood as meaning that a module can be found partly in the series circuit. In this case, too, what has been stated above in relation to the development of heat holds true.

The following embodiments relate to the second solution approach. As mentioned above, the two solution approaches and all of the associated embodiments can be combined with one another.

FIG. 6 shows another embodiment of a battery system according to the invention. The battery system comprises at least two battery modules, a bidirectional power conversion system 7, a control device 8 and, for each battery module, a DC-DC converter, of which one is denoted by 17. The battery modules are connected in series and are connected to the power conversion system 7. One terminal of the DC-DC converter 17 is connected to a respective battery module and a second terminal of the DC-DC converter 17 is connected to a respective common DC bus.

The DC-DC converters can in this case be of unidirectional or bidirectional design. Depending on the type of design and orientation, the DC-DC converters 17 can either draw electrical energy in a controlled manner from the DC bus or feed electrical energy thereto or both.

The battery system furthermore comprises another power conversion system, denoted by 16. The power conversion system 16 is connected to the DC bus. The control device 8 is connected to the power conversion system 16 and to the DC-DC converters 17 so that the control device 8 can control the power conversion system 16 and the DC-DC converters 17. The power conversion system 7 is connected to the grid or to another superordinate electrical system. The further power conversion system 16 can also be connected to the grid or to another superordinate electrical system, or can optionally be designed as a DC-DC chopper and be connected to the power conversion system 7. In the latter case, the power conversion system 16 draws power from the power conversion system 7 or outputs power thereto. The further power conversion system 16 is of unidirectional or bidirectional design.

As also described above, the power conversion system 7 ensures that a charging or discharge current can flow through the series-connected battery modules so that said battery modules can be charged or discharged in the process. The DC-DC converters 17 that are connected in parallel with each battery module now make it possible for at least a portion of the current delivered by the power conversion system 7 to be diverted around each battery module in a targeted and controlled manner when said battery module is charged. The DC-DC converter 17 in question in this case transmits electrical energy on the DC bus. As a result, the relevant battery module is charged less quickly or is not charged at all in the period in which the relevant DC-DC converter 17 is operated. In the case of discharging, one or more DC-DC converters 17 can be actuated so that the same electrical energy is transmitted from the DC bus to the associated battery module. In this case, the relevant DC-DC converter 17 is actuated in each case so that the associated battery module as a result is discharged less quickly or is not discharged at all in the period in which the relevant DC-DC converter 17 is operated.

In this case, it is clear that unidirectional DC-DC converters can be operated as just described depending on the orientation either only during charging or only during discharging. Bidirectional DC-DC converters can of course be operated both during charging and discharging.

The further power conversion system 16 in this case supplies the DC bus with electrical energy or dissipates excess energy therefrom. In the event that the further power conversion system 16 is of unidirectional design, not all of the flows of energy that are mentioned are possible, of course.

The arrangement according to FIG. 6 enables the following method for reducing imbalances that occur during the charging and discharging of the battery system, comprising at least one of the following steps:
during charging of the battery system, the DC-DC converters 17 are actuated by the control device 8 in order to reduce the difference between a first and second battery module in terms of a controlled variable so that one DC-DC converter 17 transmits so much electrical energy on the DC bus that one of the two battery modules is charged less quickly than the other battery module as a result;
during discharging of the battery system, the DC-DC converters 17 are actuated by the control device 8 in order to reduce the difference between a first and second battery module 1 in terms of a controlled variable so that one DC-DC converter 17 dissipates so much electrical energy from the DC bus that one of the two battery modules is discharged less quickly than the other battery module as a result.

The arrangement according to FIG. 6 furthermore enables, in any case when the power conversion system 16 has a separate grid terminal, for it to support the power conversion system 7 during charging or discharging of the battery modules. This is advantageous in particular when the power conversion system 7 reaches its power limits. Since this support by the DC-DC converters 17 can also take place selectively for each battery module, this can of course also be used for the balancing. In contrast to the balancing methods described previously, this mechanism leads to accelerated charging or discharging of the “slow” modules.

In another embodiment, a method according to the invention for reducing imbalances that occur during the charging and discharging of the battery system additionally comprises one of the following steps:
during charging of the battery system, the DC-DC converters 17 are actuated by the control device 8 in order to reduce the difference between a first and second battery module in terms of a controlled variable so that one DC-DC converter 17 dissipates so much electrical energy from the DC bus that one of the two battery modules is charged more quickly than the other battery module as a result;
during discharging of the battery system, the DC-DC converters 17 are actuated by the control device 8 in order to reduce the difference between a first and second battery module 1 in terms of a controlled variable so that one DC-DC converter 17 transmits so much electrical energy on the DC bus that one of the two battery modules is discharged more quickly than the other battery module as a result.

If multiple battery systems according to the invention are operated close to one another, then of course multiple systems together can use the further power conversion system 16 and the connected DC bus. Since one DC-DC converter must be present for each battery module, there is no opportunity for saving in terms of the DC-DC converters when using multiple battery systems in parallel.

FIG. 7 shows another embodiment of a battery system according to the invention. The only difference from the battery system according to FIG. 6 is that the auxiliary systems are connected to the DC bus and are fed thereby. In this way, there are additional uses for the DC bus that save costs at other places. The joint use of the DC bus and the further power conversion system for feeding the auxiliary systems of multiple battery systems that are connected in parallel is advantageous and possible without problems.

To for the embodiments of the second solution approach, a calibration step is analogously, as described above in detail in the first solution approach. In the second solution approach, however, all of the measures can of course be related to the different speed during charging or discharging of the individual module and to the period in which a different speed is used. The same also applies in terms of the statements that are made there in terms of carrying out the method with and without detection and evaluation of the measurement values that relate to the controlled variables.

In order that a redox flow battery system is set up to carry out the above-described method steps in automated fashion, the system comprises a computer system. The term computer system refers to all devices that are suitable for carrying out the described method steps in automated fashion, in particular also ICs or microcontrollers, and ASICs (application-specific integrated circuit) that are specifically developed therefor. In this case, the control device 8 itself can comprise a suitable computer system. As an alternative, the computer system can also constitute a separate device or part of a separate device. The present application is also aimed at a computer program that comprises commands that cause the battery system to execute the method steps that are described above. Furthermore, the present application is aimed at a computer-readable medium on which such a computer program is stored.

### LIST OF REFERENCE SIGNS

1 Battery module

2 Cell arrangement

3 Tank device

4 Measuring device for determining the OCV

5 Measuring device for determining the terminal voltage

6 Auxiliary system

7 Bidirectional power conversion system (PCS)

8 Control device

9 First switch

10 Second switch

11 Switching unit

12 Third switch

13 Fourth switch

14 Fifth switch

15 Resistor

16 Further bidirectional power conversion system

17 DC-DC converter

1-15. (canceled)

16. A method for reducing imbalances that occur during charging and discharging of a redox flow battery system, the method which comprises:
providing the battery system with:
at least two battery modules, a bidirectional power conversion system, and a controller, the battery modules being connected in series and connected to the power conversion system, and each battery module having a cell arrangement with a plurality of redox flow cells and a tank device for storing electrolyte and for supplying the cell arrangement with electrolyte;
for each battery module, a DC-DC converter, wherein a respective terminal of each DC-DC converter is connected to a respective battery module, and a second terminal of each DC-DC converter is connected to a common DC bus; and
a further power conversion system connected to the DC bus, and wherein the controller is connected to the further power conversion system and to the DC-DC converters so that the controller is able to control the further power conversion system and the DC-DC converters;
during a charging of the battery system, actuating the DC-DC converters by the controller in order to reduce a difference between a first and a second battery module, in terms of a controlled variable thereof, to cause one DC-DC converter to transmit so much electrical energy on the DC bus that one of the two battery modules is charged less quickly than the other battery module as a result; and
during a discharging of the battery system, actuating the DC-DC converters by the controller in order to reduce the difference between the first and second battery modules, in terms of a controlled variable thereof, to cause one DC-DC converter to dissipate so much electrical energy from the DC bus that one of the two battery modules is discharged less quickly than the other battery module as a result.

17. The method according to claim 16, wherein the DC-DC converters are of bidirectional or unidirectional design.

18. The method according to claim 16, which comprises:
during the charging of the battery system, actuating the DC-DC converters by the controller in order to reduce a difference between a first and a second battery module, in terms of a controlled variable thereof, to cause one DC-DC converter to transmit so much electrical energy on the DC bus that one of the two battery modules is charged more quickly than the other battery module as a result; and
during the discharging of the battery system, actuating the DC-DC converters by the controller in order to reduce the difference between the first and second battery modules, in terms of a controlled variable thereof, to cause one DC-DC converter to dissipate so much electrical energy from the DC bus that one of the two battery modules is discharged more quickly than the other battery module as a result.

19. The method according to claim 16, wherein each battery module comprises auxiliary systems to be supplied with current from outside of the respective battery module by way of terminals, and the method comprises connecting the terminals of the auxiliary systems to the DC bus and feeding the auxiliary systems with energy via the DC bus.

20. The method according to claim 16, which comprises, in a calibration step, determining characteristics of the individual battery modules in order to stipulate different charging and discharging speeds for the individual battery modules and lengths of time for which the different charging and discharging speeds are used.

21. The method according to claim 16, wherein the battery system comprises at least one measuring device for providing a controlled variable for each battery module, and wherein the controller is connected to the measuring device for acquiring the measurement values of the measuring device, and wherein the method further comprises:
acquiring the measurement values of the measuring device by the controller;
if at least one measurement value of a first battery module differs from a measurement value of a second battery module at a first point in time:
carrying out at least one of the following steps in order to reduce a difference between the measurement values of the first and second battery module at a later second point in time, and thereby carrying out the step in a period between the first point in time and the second point in time, the steps being:
a) during the charging of the battery system, actuating the DC-DC converters by the controller in order to reduce a difference between a first and a second battery module, in terms of a controlled variable thereof, to cause one DC-DC converter to transmit so much electrical energy on the DC bus that one of the two battery modules is charged less quickly than the other battery module as a result; and
b) during a discharging of the battery system, actuating the DC-DC converters by the controller in order to reduce the difference between the first and second battery modules, in terms of a controlled variable thereof, to cause one DC-DC converter to dissipate so much electrical energy from the DC bus that one of the two battery modules is discharged less quickly than the other battery module as a result;
c) during the charging of the battery system, actuating the DC-DC converters by the controller in order to reduce a difference between a first and a second battery module, in terms of a controlled variable thereof, to cause one DC-DC converter to transmit so much electrical energy on the DC bus that one of the two battery modules is charged more quickly than the other battery module as a result; and
d) during the discharging of the battery system, actuating the DC-DC converters by the controller in order to reduce the difference between the first and second battery modules, in terms of a controlled variable thereof, to cause one DC-DC converter to dissipate so much electrical energy from the DC bus that one of the two battery modules is discharged more quickly than the other battery module as a result.

22. The method according to claim 16, wherein the battery system comprises a first switch and a second switch for each battery module, the first switch being arranged in series with the associated battery module and the second switch being arranged in a bypass line for bypassing the associated battery module and the respectively associated first switch, and the controller being connected to each of the switches so that the controller can determine respective switch positions in order to connect the battery modules into the series circuit or to bypass the series circuit, and wherein the method further comprises:
controlling with the controller a number of battery modules in the series circuit in order to reduce a difference between a first and second battery module in terms of the controlled variable, wherein one of the two battery modules is in the series circuit for a shorter period of time than the other battery module over a period during the charging or discharging of the battery system.

23. A redox flow battery system, comprising:
at least two battery modules and a bidirectional power conversion system;
said at least two battery modules being connected in series and connected to said bidirectional power conversion system, and each said battery module including a cell arrangement having a plurality of redox flow cells and a tank device for storing electrolyte and for supplying the cell arrangement with electrolyte;
a DC-DC converter for each said battery module, said DC-DC converter having a first terminal connected to said respective battery module and a second terminal connected to a common DC bus;
a further power conversion system connected to the DC bus; and
a controller connected to said further power conversion system and to said DC-DC converters, said controller being configured to control said further power conversion system and said DC-DC converters.

24. The redox flow battery system according to claim 23, wherein said DC-DC converters are of bidirectional or unidirectional design.

25. The redox flow battery system according to claim 23, wherein each battery module comprises auxiliary systems to be supplied with current from outside of the respective battery module by way of terminals, wherein the terminals of the auxiliary systems are connected to the DC bus and are fed with energy from the DC bus.

26. The redox flow battery system according to claim 23, further comprising a first switch and a second switch for each battery module, said first switch being arranged in each case in series with the associated said battery module and said second switch being arranged in each case in a bypass line around the associated said battery module and the associated said first switch, and wherein said controller is connected to each of said first and second switches and said controller is configured to determine a respective switch position in order to connect said battery modules into the series circuit or out of the series circuit.

27. The redox flow battery system according to claim 26, wherein said first switch comprises two normally off MOSFETs with channels that are connected in series and with reverse diodes always blocking in both current directions, and wherein said second switch comprises one normally off MOSFET.

28. The redox flow battery system according to claim 23, configured to automatically reduce imbalances that occur during charging and discharging of the redox flow battery system by performing at least one of the following steps:
during the charging of the battery system, actuating the DC-DC converters by the controller in order to reduce a difference between a first and a second battery module, in terms of a controlled variable thereof, to cause one DC-DC converter to transmit so much electrical energy on the DC bus that one of the two battery modules is charged less quickly than the other battery module as a result;
during a discharging of the battery system, actuating the DC-DC converters by the controller in order to reduce the difference between the first and second battery modules, in terms of a controlled variable thereof, to cause one DC-DC converter to dissipate so much electrical energy from the DC bus that one of the two battery modules is discharged less quickly than the other battery module as a result;
during the charging of the battery system, actuating the DC-DC converters by the controller in order to reduce a difference between a first and a second battery module, in terms of a controlled variable thereof, to cause one DC-DC converter to transmit so much electrical energy on the DC bus that one of the two battery modules is charged more quickly than the other battery module as a result;
during the discharging of the battery system, actuating the DC-DC converters by the controller in order to reduce the difference between the first and second battery modules, in terms of a controlled variable thereof, to cause one DC-DC converter to dissipate so much electrical energy from the DC bus that one of the two battery modules is discharged more quickly than the other battery module as a result.

29. A computer program comprising computer code in non-transitory form configured to command a redox flow battery system to execute the method according to claim 16.

30. A computer-readable medium storing a computer program for executing the method according to claim 16 when computer-executable code of the computer program is executed by the controller.
